(19) United States
(12) Patent Application Publication
(10) Pub. No.: US 2019/0113086 A1
(43) Pub. Date: Apr. 18, 2019

(54) Reciprocating Action Drive with Magnetically Hinged Overrunning Clutch

(71) Applicant: Roy Rosser, Monmouth Junction, NJ (US)

(72) Inventor: Roy Rosser, Monmouth Junction, NJ (US)

(21) Appl. No.: 15/785,635

(22) Filed: Oct. 17, 2017

Related U.S. Application Data
(60) Provisional application No. 62/572,502, filed on Oct. 15, 2017.

(51) Int. Cl. F16D 41/36; F16D 67/06; F16D 41/28; F16H 31/00; B62M 1/26

(52) U.S. Cl. CPC F16D 41/36; F16D 67/06; B62M 1/30; F16H 31/001; B62M 1/26; F16D 41/28

(57) ABSTRACT

A reciprocating action drive having a magnetically sprung overrunning clutch with sprags that contain permanent magnets, is disclosed. The overrunning clutch has inner and outer shafts disposed to rotate about a common axis, and pivoting sprags that incorporate a permanent magnet, located between them. The sprags are shaped and sized, and located and sprung by magnetic attraction, such that the shafts rotate freely past each other in one direction, but lock together when attempted to be rotated in an opposite, lockup direction. A drive shaft is connected to either the inner or outer shaft of the overrunning clutch, and a lever arm is connected to the other shaft. When the lever arm is moved in a first rotational direction, the drive shaft is driven in that same direction. However, when the lever arm is moved in the opposite direction, the drive shaft is not driven as the overrunning clutch freewheels.

### CROSS-REFERENCE TO RELATED APPLICATIONS

This application is related to co-pending U.S. patent application Ser. No. 15/607,576 entitled “Reciprocating Action Drive”, filed on May 29, 2017, the contents of which are hereby incorporated by reference in their entirety.

This application claims priority to U.S. Ser. No. 62/572,502 entitled “Magnetically Pivoting Overrunning Clutch and Application Thereof”, filed on Oct. 15, 2017, the contents of which are fully incorporated herein by reference.

### BACKGROUND OF THE INVENTION

### (1) Field of the Invention

The invention relates to a mechanical device for converting reciprocating linear motion to rotary motion, and more particularly, to the use of one or more magnetically pivoted overrunning clutches having sprags, or pawls, containing permanent magnets, to perform that conversion.

### (2) Description of the Related Art

The technical problem of converting reciprocating linear motion to rotary motion is inherent in the technical field of mechanical drive chains.

This conversion may, for instance, be performed using a crank. However, if the input motion is close to liner, a crank's efficiency in making the motion conversion may vary with crank angle, and typically the effective conversion of linear to rotary motion is approximately proportional to the sine of the crank angle. This means that it is zero at zero crank angle, sometimes referred to as “top dead center”, and only becomes reasonably effective when the crank angle is in a range of about 30 to 120 degrees, becoming zero again at 180 degrees of crank angle.

To overcome this defect of a crank, a lever arm may be connected to the drive shaft via an overrunning clutch to effect the conversion of reciprocating liner motion to uni-directional rotary motion.

Traditional overrunning clutches typically use sprags, or pawls, that may be held in alignment by mechanical springs and mechanical races. These mechanical devices can be difficult to manufacture, assemble and repair. The mechanical springs may also be subject to failure through wear, fatigue and dirt.

What is needed is a reciprocating action drive having overrunning clutches that are simple to manufacture, assemble and repair and that are less vulnerable to failure through wear, fatigue and dirt than conventional mechanically sprung and oriented overrunning clutches.

The relevant prior art includes:

U.S. Pat. No. 584,200 issued to J. Wheatley on Jun. 8, 1897 entitled “Bicycle” that describes a sprocket-wheel mounted to rock or oscillate on a stud carried by the bicycle frame, a sprocket-chain engaging said sprocket-wheel, fulcrumed pedal-levers to which the lower ends of the chain are attached, a curved rack on the sprocket-wheel, a shaft mounted to rotate on the bicycle-frame and arranged at right angles to the axis of said sprocket-wheel, bevel-gears loosely mounted on said shaft and meshing with the curved rack, clutch devices between the shaft and gear-wheels, a sprocket-wheel rigidly secured on one end of the said shaft, and a sprocket-chain connecting said sprocket-wheel with a sprocket-wheel on the axle of the rear wheel of the bicycle.

U.S. Pat. No. 8,702,115 issued to Kramer, et al. on Apr. 22, 2014 entitled “Drive mechanism and bicycle drive system” that describes a drive mechanism (that) effects a rotary power output in response to a reciprocating power input resulting from substantially linear forces applied to the drive mechanism, such as those forces applied by a rider on a bicycle. The drive mechanism includes input bevel gears meshed with corresponding output bevel gears coupled to a common power output shaft through clutches that effect a rotary power output at the power output shaft in response to the reciprocating power input from the substantially linear forces. Opposite crank arms are coupled with the input bevel gears such that each crank arm is advanced by an applied substantially linear force, and is retracted upon advancement of the opposite crank arm. In a bicycle, opposite pedals are coupled to corresponding crank arms and are moved through predetermined power strokes in response to substantially linear forces applied by a rider to effect corresponding rotational movements of the input bevel gears and concomitant rotary power output at the power output shaft.

UK Patent Application GB 2 219 261 entitled “Reciprocating Human Drive Mechanism” filed on May 3, 1989 by inventor Alan David Ferrie that describes a bicycle drive unit consisting of a pair of angularly reciprocable pedal levers 2,3 connected to drive a hollow cylindrical casing 4 through respective pawl-and-ratchet one-way clutches 10, 11, the cycle rear wheel being chain-driven from a main sprocket wheel 5 carried by the casing 4. A motion reversing mechanism interconnects the pedals 2, 3, consisting of bevel gears 8, 9 and reversing pinions 7. The drive unit is arranged on a common cross-shaft 2 fixed to the cycle frame. The arrangement permits the drive wheel of the bicycle to be given more useful pedal effort per unit of time than a conventional crank arrangement.

U.S. Pat. No. 5,390,773 issued to Proia on Feb. 21, 1995 entitled “Non-slip bicycle clutch” that describes a clutch mechanism for use on a conventional bicycle which permits independent actuation of both pedals and provides a driving force through 100% of a pedal stroke. The clutch is generally comprised of a single, outer, cylindrical rotor which extends between the two pedals, and two internal rotors, respective to each pedal, positioned within the outer rotor. The internal rotors each include respective longitudinally extending, annularly spaced webs and longitudinally extending V-shaped portions integrally positioned between successive webs. In addition, magnets are attached to each rotor and positioned at the vortices of the V-shaped portions. The clutch further includes a set of cylindrical rods positioned between the two rotors which become wedgingly engaged between the magnets and the outer rotor when the pedal is actuated by a user of the bike. In addition, each pedal is attached to the frame of the bike via a spring which prohibits the pedal from being rotated a full 360-degree. After the pedal has been extended through a predetermined stroke, the resiliency of the spring causes the return of the pedal to its original position. This, in essence provides for 100% of the user's energy to be converted into useful work.

Various implementations are known in the art, but fail to address all of the problems solved by the invention described herein. Various embodiments of this invention are illustrated in the accompanying drawings and will be described in more detail herein below.

### BRIEF SUMMARY OF THE INVENTION

An inventive reciprocating action drive having one or more magnetically sprung overrunning clutches in which the sprags, or pawls, themselves contain at least one permanent magnet, is disclosed.

The magnetically sprung overrunning clutch may include an inner and an outer shaft disposed to rotate about a common axis of rotation. Between an inner surface of the outer shaft and the outer surface of the inner shaft, there may be a pivoting sprag. The pivoting sprag may incorporate a permanent magnet, and the pivoting sprag may be shaped, sized, sprung and located by the magnetic attraction of the sprag permanent magnet, such that the inner and outer shafts may be free to rotate past each other when rotated in a free-wheel rotational direction with respect to each other, but are locked together by the pivoting sprags when attempted to be rotated in an opposite, lockup rotational direction with respect to each other.

There may also be a drive shaft, that may be functionally connected to either the inner shaft or the outer shaft of the magnetically sprung overrunning clutch. There may also be a lever arm that may be functionally connected to which may be functionally connected to the clutch shaft to which the drive shaft is not connected, i.e., if the dive shaft is connected to the inner clutch shaft, the lever arm may be connected the outer clutch shaft, and vice-versa.

In this way the reciprocating action drive may function such that when the lever arm is moved in a first rotational direction by, for instance, a source of linear, reciprocating motion, the drive shaft may be driven in that same, first rotational direction. However, when the lever arm is moved in a second rotational direction, opposite to the first rotation direction, the drive shaft may not be driven as the shafts of the first magnetically sprung overrunning clutch may now freewheel with respect to each other.

In a further preferred embodiment of the invention, the magnetically sprung overrunning clutch may also include or more anchor magnets, located on either the inner or outer shaft of the clutch. These anchor magnets may be permanent magnets, such as, but not limited to, neodymium rare earth magnets, or they may, in alternate embodiments, be electro-magnets. The anchor magnets may serve to cooperate with the sprag magnets in magnetically attracting, and locating, the pivoting sprags to a desired location.

There may also be a second lever arm that may be functionally connected to a shaft of a second magnetically sprung overrunning clutch that may have its other shaft functionally connected to the drive shaft, in a manner analogous to the connection train from the first lever arm to the drive shaft. Such a train of functional connections may be such that when the second lever arm is moved in a first rotational direction by, for instance the source of linear, reciprocating motion, the drive shaft may be driven in the same, first rotational direction. However, when the second lever arm is moved in a second, opposite, rotational direction, the drive shaft may not be driven as the shafts of the second magnetically sprung overrunning clutch may now freewheel with respect to each other.

In a reciprocating action drive having two lever arms, the lever arms may be connected via a direction reversing mechanism such that when in the first lever arm is moved in a first rotational direction, the second lever arm may be moved in a second, opposite rotational direction. The direction reversing mechanism may be a mechanism such as, but not limited to, a beveled gear reversing mechanism, or a flexible cable and restraining channel mechanism, or some combination thereof.

Therefore, the present invention succeeds in conferring the following, and others not mentioned, desirable and useful benefits and objectives.

It is an object of the present invention to provide a simple, easy to manufacture, assemble and to repair device for more efficiently converting linear reciprocating motion into uni-directional rotary motion than a crank.

It is another object of the present invention to provide an efficient liner to rotary motion device that may be effectively used on devices such as, but not limited to, bicycles and e-bikes.

### BRIEF DESCRIPTION OF THE SEVERAL VIEWS OF THE DRAWINGS

FIG. 1 shows a schematic cross-section of a reciprocating action drive of one embodiment of the present invention.

FIG. 2 shows a schematic isometric view of a reciprocating action drive of one embodiment of the present invention.

FIG. 3 shows a schematic isometric view of a reciprocating action drive of a further embodiment of the present invention.

FIG. 4A shows a schematic side view of a reciprocating action drive of a further embodiment of the present invention.

FIG. 4B shows a schematic plan view of a reciprocating action drive of a further embodiment of the present invention.

FIG. 5 shows a schematic plan view of a reciprocating action drive with a beveled gear reversing mechanism.

FIG. 6 shows a schematic side view of a bicycle with a reciprocating action drive of one embodiment of the present invention.

FIG. 7 shows a close up, schematic side view of a bicycle with a reciprocating action drive of one embodiment of the present invention.

FIG. 8 shows a schematic, isometric view of a restraining channel having a trumpet shaped reversing surface.

FIG. 9A shows a schematic, side, cross-sectional view of a restraining channel having roller bearings.

FIG. 9B shows a schematic, plan view of a restraining channel having roller bearings.

FIG. 10A shows a schematic, plan view of a reversing mechanism having multiple uptake spools.

FIG. 10B shows a schematic, isometric view of a reversing mechanism having multiple uptake spools.

### DETAILED DESCRIPTION OF THE INVENTION

The preferred embodiments of the present invention will now be described in more detail with reference to the drawings in which identical elements in the various figures are, as far as possible, identified with the same reference numerals. These embodiments are provided by way of explanation of the present invention, which is not, however, intended to be limited thereto. Those of ordinary skill in the art may appreciate upon reading the present specification and viewing the present drawings that various modifications and variations may be made thereto without departing from the spirit of the invention.

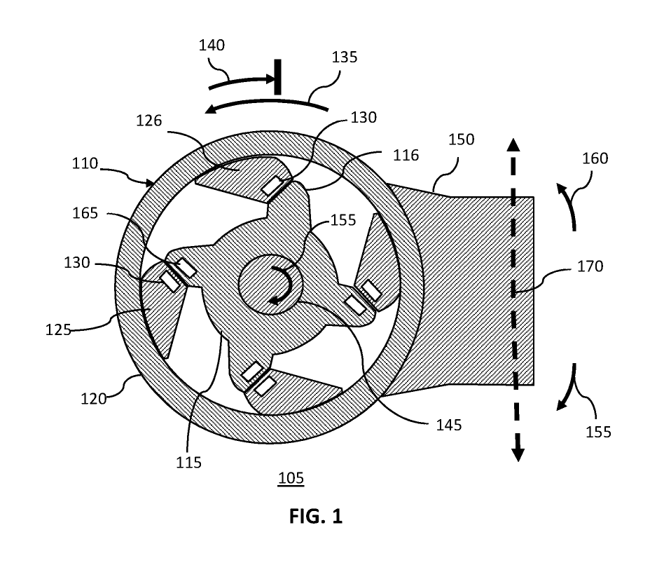

FIG. 1 shows a schematic cross-section of a reciprocating action drive of one embodiment of the present invention.

The reciprocating action drive 105 shown in FIG. 1 functionally connects a first lever arm 150 via a magnetically sprung overrunning clutch 110 to a drive shaft 145.

As shown, the magnetically sprung overrunning clutch 110 may include one or more pivoting sprags 125 situated between an outer shaft 120 of the clutch and an inner shaft 115 of the clutch that may rotate about a common axis of rotation. Each of the pivoting sprags 125 may incorporate a sprag permanent magnet 130. The pivoting sprags 125 may be shaped and sized, and the sprag permanent magnet 130 situated, such that when suitably located and sprung by the magnetic attraction of the sprag permanent magnet 130, the inner and outer shafts of the clutch may be free to rotate past each other when rotated in a free-wheel rotational direction 135 with respect to each other, but are locked together by the pivoting sprags when attempted to be rotated in an opposite, lockup rotational direction 140 with respect to each other.

In FIG. 1, the first lever arm 150 is shown functionally connected to the outer shaft 120 of the magnetically sprung overrunning clutch 110 and the drive shaft 145 is shown functionally connected to the inner shaft 115 of the first magnetically sprung overrunning clutch 110, and the pivoting sprags 125 shaped and located such that when the first lever arm 150 is moved by, for instance, a source of linear, reciprocating motion 170 in a first rotational direction 155, the drive shaft 145 may also be moved to rotate in the same, first rotational direction 155. However, when the first lever arm 150 is moved in the second, rotational direction 160 the first magnetically sprung overrunning clutch 110 may freewheel, and the drive shaft 145 may not be driven.

One of ordinary skill in the art will, however, appreciate that the first lever arm 150 may instead be connected to the inner shaft 115 of the first magnetically sprung overrunning clutch 110 and the drive shaft 145 to the outer shaft 120 of the clutch, and a similar effect obtained and the linear reciprocating motion applied to the first lever arm 150 translated into unidirectional, driven, rotational motion of the drive shaft 145.

FIG. 1 shows an exemplary pivoting sprag 126 having a sprag permanent magnet 130 located with respect to a suitably shaped portion 116 of the inner shaft. In such an arrangement, the suitably shaped portion 116 of the inner shaft may be made of a ferromagnetic material such as, but not limited to, steel, iron, ferritic stainless steel, or some combination thereof. The suitably shaped portion 116 of the inner shaft may also, or instead, have a suitable portion made of such a ferromagnetic material. The magnetic attraction of the sprag permanent magnet 130 to the suitably shaped portion 116 of the inner shaft may locate and “spring” the exemplary pivoting sprag 126 so as to effect the desired working of the magnetically sprung overrunning clutch 110.

FIG. 1 also shows an anchor magnet 165. As shown in FIG. 1, the anchor magnets 165 may be incorporated into the inner shaft 115 so as to further facilitate the ability of the sprag permanent magnet 130 to magnetically attract, and so locate, orient and “spring” the pivoting sprags 125 so as to effect the desired working of the magnetically sprung overrunning clutch 110.

One of ordinary skill in the art will further appreciate that the anchor magnets 165 may instead be incorporated into the outer shaft 120 of the clutch, or a suitably shaped portion of it, and the pivoting sprags 125 shaped, sized, oriented and located so as to effect the desired working of the magnetically sprung overrunning clutch 110.

Both the sprag permanent magnet 130 and the anchor magnets 165 may be rare earth permanent magnet such as, but not limited to, neodymium rare earth magnet. In alternate embodiments, the anchor magnets 165 may also, or instead, be electro-magnets.

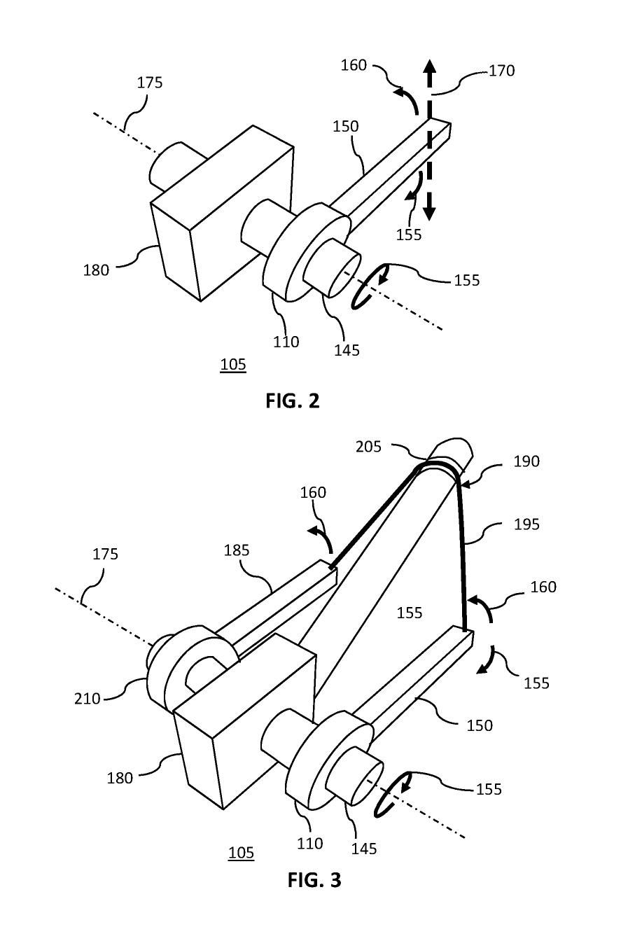

FIG. 2 shows a schematic isometric view of a reciprocating action drive of one embodiment of the present invention.

The reciprocating action drive 105 may include a first lever arm 150 attached to a first magnetically sprung overrunning clutch 110 that in turn may be attached to a drive shaft 145 that may be rotatingly supported by a frame 180. The first lever arm 150, the first magnetically sprung overrunning clutch 110 and the drive shaft 145 may all rotate about a common first axis of rotation 175.

The first lever arm 150 may be moved by, for instance, a source of linear, reciprocating motion 170 to move in a first rotational direction 155, and in doing so, may, via the first magnetically sprung overrunning clutch 110, may drive the drive shaft 145 to move in the same first rotational direction 155. However, when the first lever arm 150 may be moved in the second, opposite, rotational direction 160 by, for instance, the source of linear, reciprocating motion 170, the first magnetically sprung overrunning clutch 110 may freewheel, and the drive shaft 145 may not be driven to move.

FIG. 3 shows a schematic isometric view of a reciprocating action drive of a further embodiment of the present invention.

The reciprocating action drive 105 shown in FIG. 3 incorporates both a first lever arm 150 and a second lever arm 185 that are coupled to a first rotational direction 155 via, receptively, a first magnetically sprung overrunning clutch 110 and a second magnetically sprung overrunning clutch 210.

The two magnetically sprung overrunning clutch, the two lever arms, and the drive shaft may all rotate around a common first axis of rotation 175, and the drive shaft 145 may be rotationally supported in a fixed frame 180.

This arrangement may be such that when either the first lever arm 150 or the second lever arm 185 are moved to rotate in a first rotational direction 155, the drive shaft 145 may also be driven to rotate in the first rotational direction 155. However, when either of the lever arms are rotated in a second, opposite, rotational direction 160, their respective magnetically sprung overrunning clutch 110 may freewheel, and they may not drive the drive shaft 145.

The reciprocating action drive 105 with two lever arms may also incorporate a direction reversing mechanism 190 that may link the lever arms such that when one is rotated in a first rotational direction 155 the over may be moved to rotate in a second, opposite, rotational direction 160. Such an arrangement may, for instance, facilitate an arm not being driven by a source of linear, reciprocating motion, to be moved back into position to be available to be moved on a next stroke of the source of linear, reciprocating motion.

The direction reversing mechanism 190 shown in FIG. 3 shows a flexible cable 195 linking the first lever arm 150 to the second lever arm 185 via a restraining channel 205.

One of ordinary skill in the art will, however, appreciate that many other mechanisms may be used as a direction reversing mechanism 190 as will be described in more detail below.

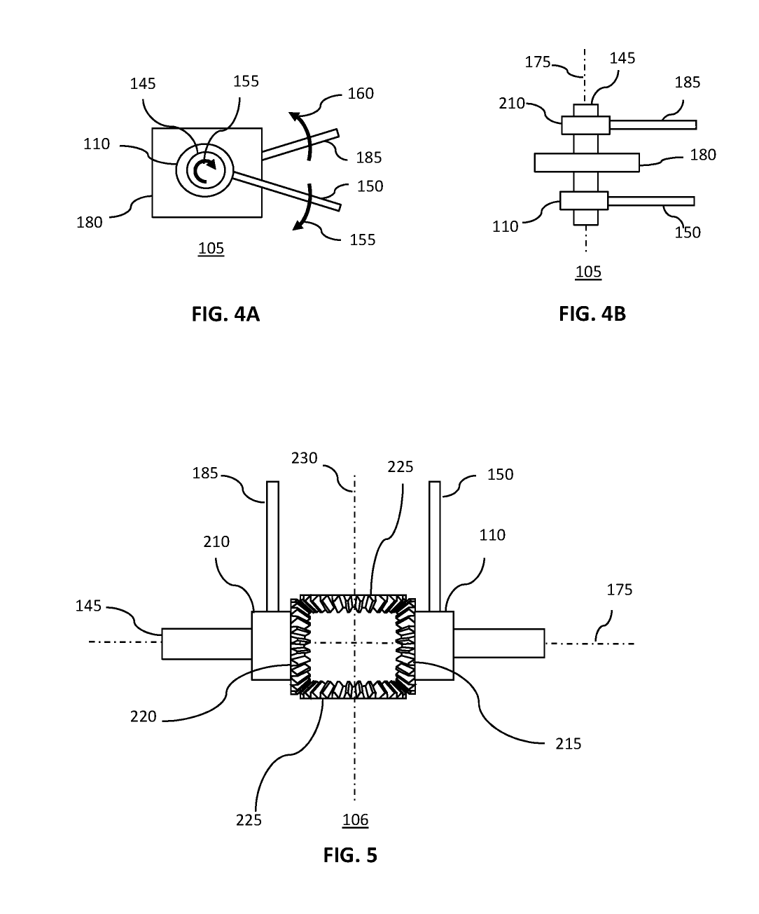

FIG. 4 A shows a schematic side view of a reciprocating action drive of a further embodiment of the present invention.

The reciprocating action drive 105 may have a first lever arm 150 and a second lever arm 185. As shown, the first lever arm 150 may be functionally connected to a first magnetically sprung overrunning clutch 110 that in turn be functionally connected to a drive shaft 145. The drive shaft 145 may be supported, but free to rotate, in a frame 180. When the first lever arm 150 or second lever arm 185 are rotated in a first rotational direction 155, their respective magnetically sprung overrunning clutches may move the drive shaft 145 to also move in a first rotational direction 155. However, moving either of the lever arms in a second, rotational direction 160 may not move the drive shaft 145 as their respective overrunning clutches may be in freewheeling mode.

FIG. 4 B shows a schematic plan view of a reciprocating action drive of a further embodiment of the present invention.

The reciprocating action drive 105 shown in FIG. 4 B may include a drive shaft 145, a first magnetically sprung overrunning clutch 110 and a second magnetically sprung overrunning clutch 210, all of which may rotate about a common first axis of rotation 175. The drive shaft 145 may be supported by, and free to rotate within, a frame 180. A first lever arm 150 and a second lever arm 185 may be connected to the first magnetically sprung overrunning clutch 110 and the second magnetically sprung overrunning clutch 210 respectively, so as to function as a reciprocating action drive 105.

FIG. 5 shows a schematic plan view of a reciprocating action drive with a beveled gear reversing mechanism.

The embodiment shown in FIG. 5 has both a first lever arm 150 and a second lever arm 185, both connected via their respective magnetically sprung overrunning clutches 110 and 210 to the drive shaft 145, all of which rotate about a common first axis of rotation 175.

The magnetically sprung overrunning clutches are, however, connected via a direction reversing mechanism that, in this instance, may include a first and second beveled gears 215, 220, each connected via their respective magnetically sprung overrunning clutches to their respective ever arms 150 and 185. The beveled gears 215 and 220 that rotate about the first axis of rotation 175, may in turn be functionally connected to each other via one or more third bevel gears 225. The third bevel gears 225 may rotate about a second axis of rotation 230 that may be orthogonal to the first axis of rotation 175.

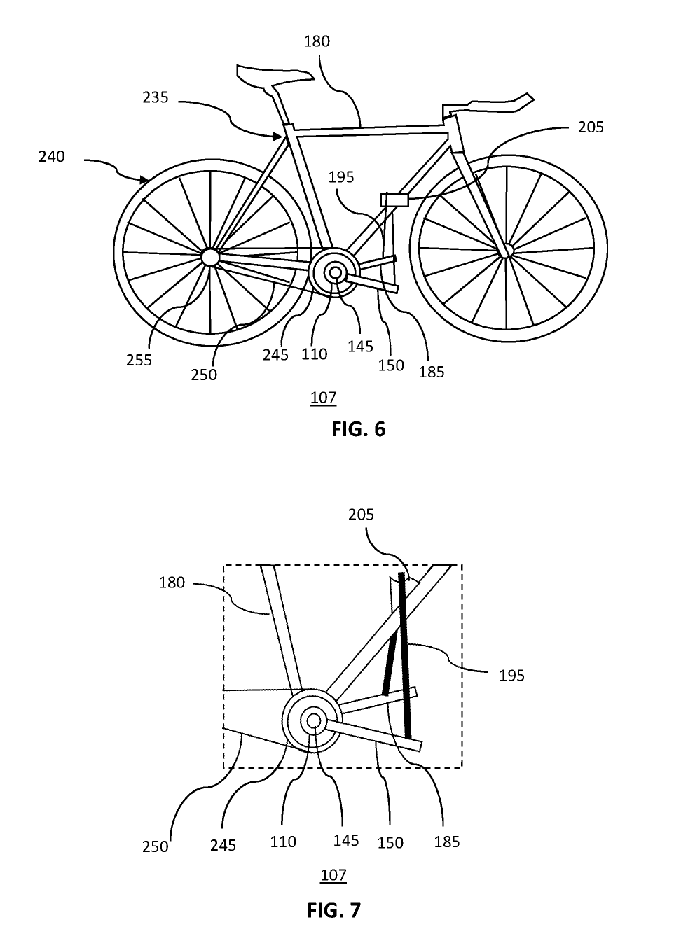

FIG. 6 shows a schematic side view of a bicycle with a reciprocating action drive of one embodiment of the present invention.

The bicycle 107 with a reciprocating action drive shown in FIG. 6 has a bicycle 235 that includes a frame 180, a bicycle rear wheel 240 and a drive chain that includes a chain ring 245 and a drive chain 250 that are used to turn the bicycle rear wheel 240 via a sprocket hub 255.

The chain ring 245 may be driven via a reciprocating action drive that includes two first lever arms 150 and 185 that are linked to a drive shaft 145 via two magnetically sprung overrunning clutches 110 in the manner described above. The drive shaft 145 may be functionally connected to the chain ring 245 to complete the drive chain.

The bicycle 107 with a reciprocating action drive shown in FIG. 6 includes a direction reversing mechanism in the form of a flexible cable 195 that connects the first and second lever arms 150 and 185 via a restraining channel 205 that may be a part of, or attached to the frame 180. Such an arrangement may mean that when the first lever arm 150 is moved in a first direction of rotation, the second lever arm 185 is moved in said second, opposite direction of rotation. This may be beneficial to a cyclist in that when a pedal attached to the first lever arm 150 has been moved done, and the cyclist's one leg is fully, or nearly fully extended, a pedal attached to the second lever arm 185 may now have been moved upward to a position suitable for the cyclist to apply a downward force with their other leg.

The flexible cable 195 may, for instance, be a cable such as, but not limited to, a stainless steel lanyard, or sized cable, rope or tape, may be made of a material or fibers, such as, but not limited to, stainless steel, steel, aluminum, Nylon™, Kevlar™, polyester, polypropylene, poly-aramid, cotton, leather, wool, or silk, or some combination thereof. One of ordinary skill in the art will, however, appreciate that the reversing mechanism may instead be one of a variety of devices such as, but not limited to, those described throughout this document.

FIG. 7 shows a close up, schematic side view of a bicycle with a reciprocating action drive of one embodiment of the present invention.

The bicycle 107 with a reciprocating action drive shown in FIG. 7 may be driven by the lever arms 150 and 185 that are connected to a drive shaft 145 via magnetically sprung overrunning clutches 110. The drive shaft 145, which may be supported by, but free to rotate within the frame 180, may, in turn, be directly, or functionally, connected to a chain ring 245 that drives a drive chain 250 which may power the bicycle via its rear wheel.

The bicycle 107 with a reciprocating action drive shown in FIG. 7 also includes a direction reversing mechanism in the form of a flexible cable 195 that connects the first and second lever arms 150 and 185 via a restraining channel 205 that may be a part of, or attached to the frame 180. Such an arrangement may mean that when the first lever arm 150 is moved in a first direction of rotation, the second lever arm 185 is moved in said second, opposite direction of rotation. This may be beneficial to a cyclist in that when a pedal attached to the first lever arm 150 has been moved done, and the cyclist's one leg is fully, or nearly fully extended, a pedal attached to the second lever arm 185 may now have been moved upward to a position suitable for the cyclist to apply a downward force with their other leg.

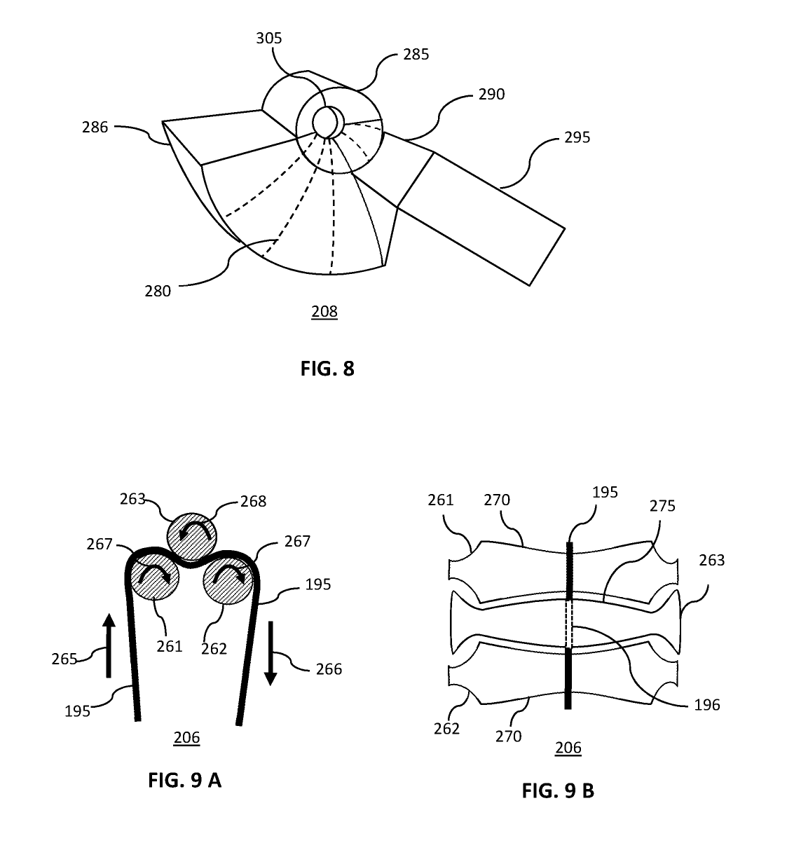

FIG. 8 shows a schematic, isometric view of a restraining channel having a trumpet shaped reversing surface.

The restraining channel 207 having a trumpet shaped reversing surface shown in FIG. 8 may include a lower restraining unit 286 and a upper restraining unit 285. Together these may form a restraining annulus 305 through which a flexible cable may pass. The lower restraining unit 286 may have a trumpet shaped reversing surface 280, and may be connected via a connecting arm 290 to a frame connection bracket 295. The frame connection bracket 295 may, for instance, be a part of, or connected to, a bicycle frame.

FIG. 9A shows a schematic, side, cross-sectional view of a restraining channel having roller bearings.

As shown in FIG. 9 A, the restraining channel of the direction reversing mechanism has three roller bearings, 261, 262 and 263, arranged such that a flexible cable 195 passes through them, and is constrained by them, using a minimal amount of frictional force.

The flexible cable 195 may, for instance, be pulled downward in a downward motion 266. In doing so, first and second roller bearings 261 and 262 may be moved in a clockwise rotational direction 267, while containing third roller bearing 263 may be moved in anticlockwise rotational direction 268. Pulling downward on the flexible cable 195 on the right hand side (as shown in FIG. 9 A) may result in the flexible cable 195 on the left hand side being pulled in an upward motion 265, thus facilitating the direction reversing function of the device.

FIG. 9B shows a schematic, plan view of a restraining channel having roller bearings.

As shown in FIG. 9 B, the restraining channel 206 having roller bearings has a flexible cable 195 that may be threaded through the roller bearings, going over first and second roller bearings 261 and 262, but under third roller bearing 263 as represented by the flexible cable 196 passing under a roller.

The roller bearings may have shaped surfaces to help constrain the flexible cable while allowing it to assume a suitable orientation for functioning to act as a reversing mechanism. The first and second roller bearing 261 and 262 may, for instance, have a concave surface 270, while the third roller bearing 263 may have a complementary convex surface 275. In combination, these shaped surfaces may help constrain the flexible cable 195 to assume a central position with respect to the roller bearings.

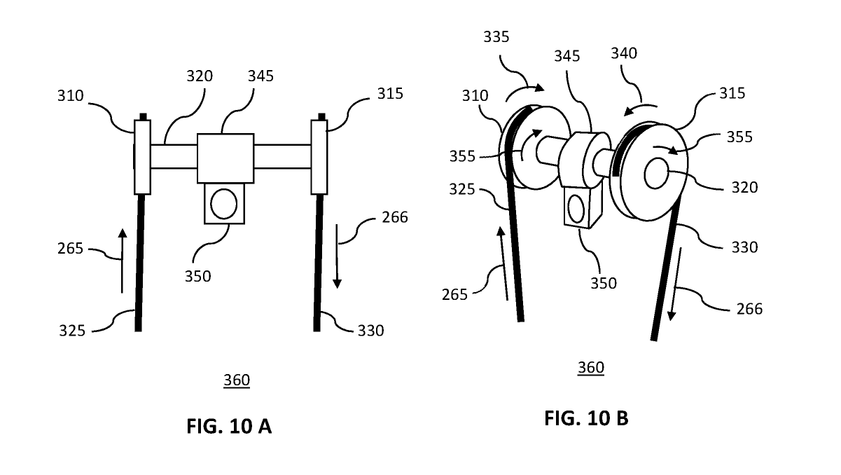

FIG. 10A shows a schematic, plan view and FIG. 10 B shows a schematic, isometric view of a reversing mechanism having multiple uptake spools 360.

A first uptake spool 310 may, for instance, have a first flexible cable 325 wound onto the spool in a first spooling direction 335, while a second uptake spool 315 may have a separate, second flexible cable 330 wound onto it in a second spooling direction 340. The first and second uptake spools, 310 and 315, may be connected via a shaft 320 that may be supported by a shaft support 345 that may, in turn be connected via a frame mounting bracket 350 to, for instance, a bicycle frame. If, for instance, the second flexible cable 330 that may be connected to a second lever arm, is moved with a downward motion 266, The second flexible cable 330 may unwind and cause the second uptake spool 315 and the shaft 320 to both rotate in a first rotational direction 355. The shaft may, in turn, cause the first uptake spool 310 to also rotate in the first rotational direction 355, resulting in the first flexible cable 325 being moved with an upward motion 265 as the cable is spooled onto the spool. In this way, the first lever arm to which the first flexible cable 325 may attached, may also be caused to move in an upward direction.

One of ordinary skill in the art will appreciate that the reversing mechanism having multiple uptake spools 360 may also operate in the opposite direction, i.e., a downward motion on the first flexible cable 325 may result in an upward motion on the second flexible cable 330.

The flexible cables may be any suitably sized cable, rope or tape, may be made of a material or fibers, such as, but not limited to, stainless steel, steel, aluminum, Nylon™ Kevlar™, polyester, polypropylene, poly-aramid, cotton, leather, wool, or silk, or some combination thereof.

In a further embodiment of a reversing mechanism having multiple uptake spools 360, the shaft support 345 may further incorporate a reversing mechanism such as, but not limited to, a beveled gear reversing mechanism as described above, and both the first and second uptake spools may have the flexible cables wound onto them in the same direction.

Although this invention has been described with a certain degree of particularity, it is to be understood that the present disclosure has been made only by way of illustration and that numerous changes in the details of construction and arrangement of parts may be resorted to without departing from the spirit and the scope of the invention.

The invention claimed is:

1. A reciprocating action drive, comprising:
a first magnetically sprung overrunning clutch, said magnetically overrunning clutch comprising:
an inner shaft and an outer shaft disposed to rotate about a common axis of rotation; and
one or more pivoting sprags located between an inner surface of said outer shaft and an outer surface of said inner shaft, said pivoting sprags each comprising a sprag permanent magnet, and, wherein, said pivoting sprags are shaped and sized, and sprung and located by magnetic attraction, such that said inner and outer shafts are free to rotate past each other when rotated in a free-wheel rotational direction with respect to each other, but are locked together by said pivoting sprags when attempted to be rotated in an opposite, lockup rotational direction with respect to each other;
a drive shaft functionally connected to one of said inner shaft or said outer shaft of said magnetically sprung overrunning clutch; and
a first lever arm functionally connected to the shaft of the magnetically sprung overrunning clutch to which the drive shaft is not connected, thereby enabling said drive shaft to be driven in a first rotational direction when said first lever arm is moved in said first rotational direction, but not to driven when said first lever arm is moved in a second, rotational direction, opposite to said first rotational direction.

2. The reciprocating action drive of claim 1, further comprising one or more anchor magnets located in either said inner shaft or said outer shaft, and, wherein, said anchor magnets locate said pivoting sprags by magnetic attraction.

3. The reciprocating action drive of claim 2, wherein said anchor magnets are permanent magnets.

4. The reciprocating action drive of claim 1, further comprising:
a second lever arm functionally connected to a shaft of a second magnetically sprung overrunning clutch to which the drive shaft is not connected, thereby enabling said drive shaft to be driven in said first rotational direction when said second lever arm is moved in said first rotational direction, but not to driven when said second lever arm is moved in said second, rotational direction opposite to said first rotational direction.

5. The reciprocating action drive of claim 4, further comprising:
A direction reversing mechanism functionally attaching said first lever arm to said second lever arm such when said first lever arm is moved in said first direction of rotation, said second lever arm is moved in said second, opposite direction of rotation.

6. The reciprocating action drive of claim 4, wherein, said direction reversing mechanism comprises:
a first beveled gear functionally connected to said first lever arm; a second beveled gear functionally connected to said second lever arm; and one or more third bevel gears functionally connecting said first beveled gear to said second beveled gear.

7. The reciprocating action drive of claim 5, wherein, said first and second beveled gears and said drive shaft rotate about a first axis of rotation, and said third bevel gears rotate about a second axis of rotation that is orthogonal to said first axis of rotation.

8. The reciprocating action drive of claim 4, wherein, said direction reversing mechanism comprises:
a flexible cable connecting said first lever arm to said second lever arm, and, wherein, said flexible cable passes over a restraining channel attached to, or a part of, said frame such that when said first lever arm is moved in said first direction of rotation, said second lever arm is moved in said second, opposite direction of rotation.

9. The reciprocating action drive of claim 8, wherein, said flexible cable is a stainless steel lanyard.

10. The reciprocating action drive of claim 8, wherein, said restraining channel further comprises one or more roller bearings.

11. The reciprocating action drive of claim 8, wherein, said restraining channel further comprises a trumpet shaped reversing surface.

12. The reciprocating action drive of claim 4, wherein, said direction reversing mechanism comprises:
a first uptake spool and a second uptake spool, said uptake spools being functionally linked by a shaft;
a first flexible cable linked to said first lever arm and wound around said first uptake spool in a first spooling direction; and
a second flexible cable linked to said second lever arm and wound around said second uptake spool in a second spooling direction, opposite to said first spooling direction;
thereby forming said direction reversing mechanism in which, when said shafts. and said first and second uptake spools, are rotated in a first rotational direction, said first flexible cable moves with an upward motion while said second flexible cable moves with a downward motion and vice-versa.

13. The reciprocating action drive of claim 1, wherein said sprag permanent magnet is a rare-earth, permanent magnet.

14. The reciprocating action drive of claim 2 wherein one or more of said anchor magnets is an electro-magnet.
